(19) United States
(12) Patent Application Publication
(10) Pub. No.: US 2011/0186029 A1
(43) Pub. Date: Aug. 4, 2011

(54) Sealing System For Combination Oven

(76) Inventors: Daniel J. Swayze, Colchester, VT (US); Jiri Rabas, Lynnwood, WA (US)

(21) Appl. No.: 12/700,501

(22) Filed: Feb. 4, 2010

(51) Int. Cl. E06B 7/16; E05D 15/00; F24C 15/02

(52) U.S. Cl. 126/190; 49/70

(57) ABSTRACT

An oven is provided. The oven includes a housing defining an internal cooking volume defined by a plurality of side walls, a front wall, and a bottom wall and a source of heat disposed in conjunction with the cooking volume. First and second doors are pivotably mounted to the front wall, each door is disposed proximate to opposite side walls of the housing, the first and second doors are pivotable between a first position to allow access to the cooking volume through an aperture in the front wall and a second position to enclose the cooking volume. A straight and elongate first gasket is disposed upon one of the first or second doors such that the gasket engages the other of the first and second doors when the doors are in the second position, the first gasket forms a seal between an elongate interface between the first and second doors when in the second position. A second gasket is disposed upon the front wall along a perimeter of the housing, wherein the first gasket contacts a portion of the second gasket when the first and second doors are in the second position.

### TECHNICAL FIELD

The subject disclosure relates to the field of combination (Combi) baking ovens, such as ovens that provide each of radiant heat, convection air flow through the heating compartment, and a source of humidity within the oven for cooking purposes.

### BRIEF SUMMARY

A first representative embodiment of the disclosure is provided. The first embodiment includes an oven. The oven includes a housing defining an internal cooking volume and an opening to access the internal cooking volume and a radiant heat source disposed in conjunction with the cooking volume. A source of liquid is disposed in conjunction with the cooking volume and configured to provide steam within the internal cooking volume. First and second doors are pivotably connected to opposite side walls of the housing and pivotable between a first position to allow access to the cooking volume and a second position to enclose the cooking volume. The first and second doors each include an inner surface that each are disposed within substantially the same plane when the first and second doors are in the second position. A first gasket is fixed to an end surface of the first door, the first gasket includes a cantilevered extended portion that is internally compressed by continuous contact with an inner edge of the inner surface of the first door along the length thereof, wherein the first gasket establishes continuous contact with and is inwardly compressed by an inner edge of the inner surface of the second door along the length thereof when the first and second doors are in the second position. A second gasket is disposed upon the housing and surrounds the opening, the second gasket includes a body portion fixed to the housing and a finger extending arcuately therefrom. The finger of the second gasket is configured to contact the inner surface of the each of the first and second doors and the extended portion of each opposite end of the first gasket when the first and second doors are in the second position.

A second representative embodiment of the disclosure is provided. The second embodiment is an oven that includes a housing defining an internal cooking volume defined by a plurality of side walls, a front wall, and a bottom wall. A source of heat disposed in conjunction with the cooking volume and first and second doors are pivotably mounted to the front wall. Each door is disposed proximate to opposite side walls of the housing. The first and second doors are pivotable between a first position to allow access to the cooking volume through an aperture in the front wall and a second position to enclose the cooking volume. A straight and elongate first gasket is disposed upon one of the first or second doors such that the gasket engages the other of the first and second doors when the doors are in the second position, the gasket forms a seal between an elongate interface between the first and second doors when in the second position. A second gasket is disposed upon the front wall along a perimeter of the housing, wherein the first gasket contacts a portion of the second gasket when the first and second doors are in the second position.

Still another representative embodiment of the disclosure is provided. The embodiment includes an oven that includes a housing forming a cooking chamber that is enclosed by upper, right, left, lower, rear, and front walls, with an aperture disposed within the front wall. The cooking chamber is selectively isolated by first and second doors that are pivotably mounted to right and left portions of the front side, respectively. The first and second doors are pivotable between an open position and a closed position where the first and second doors are substantially parallel with an inner surface of each of the first and second doors enclosing the cooking volume. A vertical edge between inner edges of each of the first and second doors is isolated by a first gasket that is fixed to one of the first and second doors that sealingly contacts the inner edges of each door when the doors are in the second position. A second gasket is provided upon the front surface and surrounding the aperture, with the second gasket including an arcuate cantilevered finger that engages the outer edges of the first and second doors when in the second position to substantially prevent fluid communication from the cooking chamber to the environment when the first and second doors are in the closed position.

Advantages of the disclosed rack of use will become more apparent to those skilled in the art from the following description of embodiments that have been shown and described by way of illustration. As will be realized, other and different embodiments are contemplated, and the disclosed details are capable of modification in various respects. Accordingly, the drawings and description are to be regarded as illustrative in nature and not as restrictive.

### BRIEF DESCRIPTION OF THE DRAWINGS

FIG. 1 is a perspective view of an oven.

FIG. 2 is a top sectional view of the oven of FIG. 1 with the first and second doors in the open position to allow access to the heating compartment.

FIG. 3 is the view of FIG. 2, with the first and second doors in the closed position to isolate the heating compartment.

FIG. 3A is a detail view of section A of FIG. 3.

FIG. 4 is a perspective view of a section of the doors and housing of the oven of FIG. 1 with the first and second doors in the closed position.

FIG. 5 is a side sectional view of the oven of FIG. 1 showing the second door in the closed position and engagement between the second door and the second gasket.

FIG. 5A is a detail view of detail B of FIG. 5, showing engagement between an upper second gasket and the inner pane of the second door.

FIG. 5B is a detail view of detail C of FIG. 5, showing engagement between a lower portion of the second gasket and the inner pane of the second door.

FIG. 6 is a perspective view of the first gasket of the oven of FIG. 1.

FIG. 7 is an end view of the first gasket of FIG. 6

FIG. 8 is a perspective view of the second gasket of the oven of FIG. 1.

FIG. 9 is a perspective view of the lower and a section of the right and left side portions of the gasket of FIG. 8.

FIG. 10 is a top view of the portion of the gasket depicted in FIG. 9.

### DETAILED DESCRIPTION

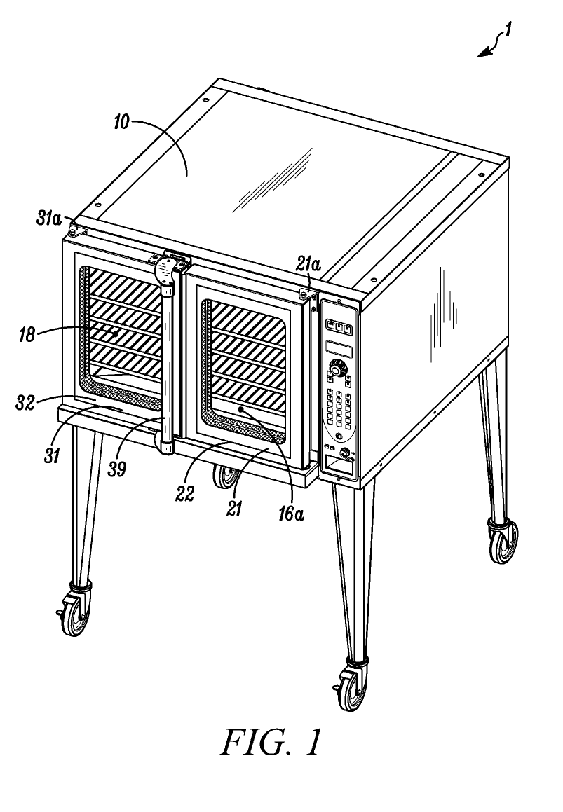

Turning now to FIGS. 1-10, an oven 1 is provided. The oven 1 includes a housing 10 and an internal heating cavity 18. The heating cavity 18 is defined and enclosed by an upper wall 11, a rear wall 15, a right wall 12, a left wall 14, a front wall 16, and a bottom wall 15, each fixed within an oven housing 10. The heating cavity 18 is configured to receive food items to be cooked upon one or more racks disposed therewithin. One or more heat sources are disposed either within the heating cavity 18, or otherwise within the housing 10 and in communication with the heating cavity 18 such that heat generated by the heat source is received and maintained within the heating cavity 18 to heat and cook one or more food products, or pans of food products, disposed within the heating cavity.

The heat source may include one or more gas or electric burners and the other associated components (both heating and control components) typically associated with a conventional commercial oven, whether standard or Combi oven. For example, the oven may include one or more gas burners or electric heating components either within the heating compartment 18 or in thermal communication therewith. The oven 1 may additionally include a convection heating system with an internal blower or other internal air moving structure to provide a continuous flow of heated air within the heating cavity 18, which causes food products disposed within the heating cavity 18 to receive heat by convective heat transfer due to heated air flowing past the outer surface of the food product placed therewithin. The oven 1 may additionally include a steam generation system to provide a humid environment within the heating cavity 18 and in some embodiments a steam system that operates in conjunction with the convention system to provide a steady or cyclic flow of steam or intermediate quality air to flow through the heating cavity 18 to heat the food items disposed therewithin.

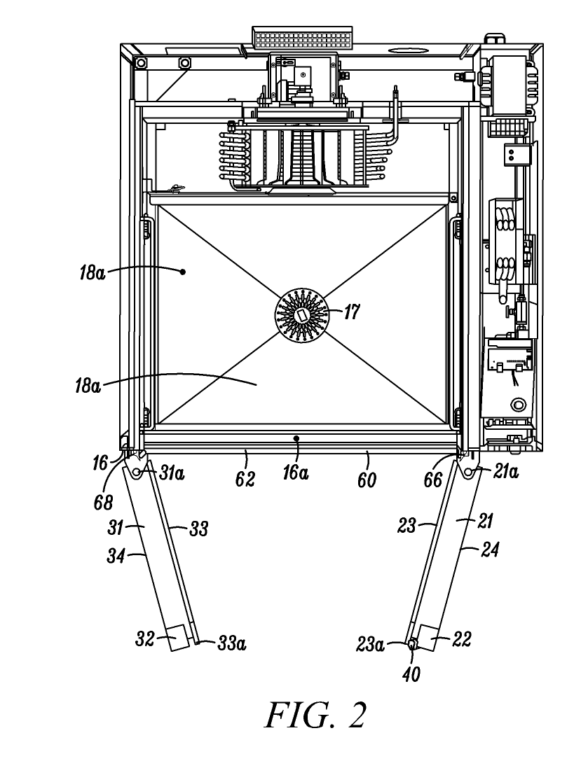

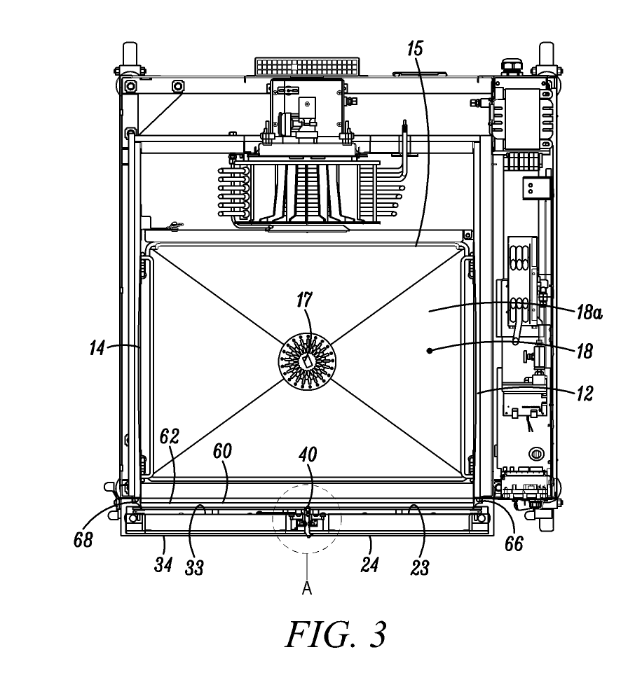

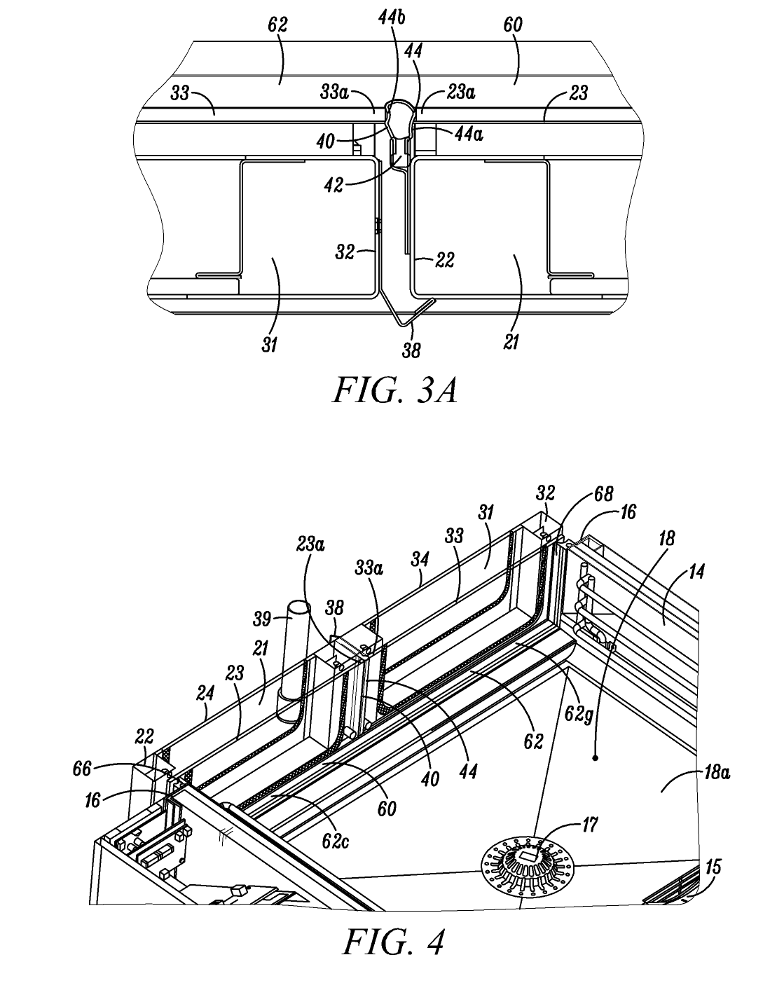

The front wall 16 of the housing includes an opening 16a defined therein, which provides the normal path for the user to access the heating cavity 18. The front wall 16 includes right, left, upper, and lower portions that are each disposed substantially along the same plane at the respective geometric location of that wall. First and second doors 21, 31 are pivotably mounted upon the right and left portions of the front wall 16, respectively, to allow for selective access of the heating cavity 18 when one or both of the doors are in the open position (FIG. 2) and provide both thermal and physical isolation of the heating cavity 18 when the first and second doors 21, 31 are in the closed position (FIGS. 1, 3). In other embodiments, the first door 21 may be mounted upon the left portion of the front wall 16 and the second door 31 may be mounted upon the right portion of the front wall 16. In still other embodiments, the first and second doors 21, 31 may be disposed such that one door is mounted to the top surface of the front wall 16 and the second door 31 is mounted to the bottom surface of the front wall 16, with the doors operating such that in the second closed position the edge between the first and second doors 21, 31 is aligned horizontally across the opening 16a into the heating cavity 18. While the specification and figures specifically describe and depict an embodiment where there first door 21 is pivotably mounted to the right side of the front surface 16 and the second door 31 is pivotably mounted to the left side of the front surface 16, the other possible orientations of the doors discussed above, and elsewhere in this specification, are similarly contemplated as substitutes for the embodiments specifically depicted herein.

The disclosed oven 1 is an improvement over conventional combi oven designs that traditionally include only a single door to isolate the heating compartment. When a single door is provided, the size of the door must be larger than the cross-sectional area of the opening into the heating compartment with sufficient area outward of each edge of the heating compartment to provide for sufficient sealing of the heating compartment. Because the doors of conventional combi ovens are relatively large, the kitchen, galley, or other cooking facility must include sufficient space for the large door to pivot to the open position, with extra room around the fully open door to prevent repeated unintended contact with the open door by cooking personnel that could cause injuries. The present embodiments that include two doors that work in concert to isolate a heating volume of a combi oven allows the doors to each be about half of the size of the single door for the same size oven, which minimizes the amount of space in the kitchen or galley that must be reserved for door operation. The present design with first and second gaskets 40, 60 working in conjunction with the first and second doors 21, 31 to substantially prevent leakage allows the dual door system to be used in a combi oven that includes humidity or steam without any leakage concerns at the edge where the inner edges come into close contact when the doors are closed, and at the edges housing with respect to the doors and the gasket connecting the two doors.

The first and second doors 21, 31 may be pivotably mounted upon the front surface 16 with hinged or pinned connections 21a, 31a. In some embodiments the first and second doors are configured such that both doors pivot open and closed together, and are linked together for consistent movement with a transmission. For example, a chain, cord, linkage, or other transmission may be operatively engaged with both doors 21, 31 such that a force provided upon one door is simultaneously transferred to the opposite door. In embodiments where both the first and second doors 21, 31 operate simultaneously, a handle 39 need only be disposed on one door, such as upon the second door 31 (FIG. 1), which allows the user to open both the first and second doors 21, 31 simultaneously with a single hand, leaving the user's other hand free to carry and hold a pan or other item normally used in an oven. In some embodiments, the first and second doors 21, 31 are configured to be normally latched shut when in the second position to avoid spurious and unintended opening of the doors. The handle 39 may be configured to allow the doors to be unlatched and opened using a single hand, such as by pivoting the handle in a direction, such as leftward or right ward and then pulling the handle away from the housing to cause the second door 31 to pivot open, which causes the first door 21 to similarly open due to the transmission. A suitable design for the handle and a door opening and closing mechanism that may be provided with the handle 39 has been disclosed in commonly owned U.S. Published application No. 2008/0276925, the entirety of which is fully incorporated by reference herein.

In some embodiments, the first and second doors 21, 31 are configured with dampening systems operation in conjunction with the pivot connection or the transmission that substantially prevent movement of the first and second doors in either the opening or closing direction when not in receipt of a force applied thereupon by the user. The dampening system may be provided as a safety component to prevent spurious or unintended motion closing the doors 21, 31 when a user's hand or arm is extended between the doors, which could cause burns to the user if the user's skin were to contact the inner panes 23. 33 or other components of the doors 21, 31 during operation. In some embodiments, the dampening of pivoting motion of the first and second doors 21, 31 may be obtained from the internal friction with the door transmission.

In some embodiments, each of the first and second doors include at least two panes of glass, plastic or another transparent or semi transparent material. Each door may include an inner pane 23, 33 and an outer pane 24, 34 each disposed substantially parallel to the other pane on the same door. The inner pane 23, 33 is the surface that forms the immediate isolation barrier of the heating volume 18 when the first and second doors 21, 31 are in the closed position. The outer panes 24, 34 of each of the first and second doors 21, 31 may be mounted with respect to the door 21,31 to form the outer surface of the door. In some embodiments, each door additionally includes a frame 22, 32 that mechanically and fixedly holds the two or more panes of each door and with respect to each other and provides the door-mounted portion of the respective first and second hinge 21a, 31a. In some embodiments, a low-e glass or low-e may be provided for the inner and/or outer panes, and in some embodiments, a low conductive gas (such as argon or krypton) may be charged between the inner and outer panes to minimize the heat loss through the first and second doors 21, 31 from the cavity 18 during oven operation.

The first and second doors 21, 31 operate in conjunction with at least two gaskets to minimize and substantially eliminate leakage from the heating compartment 18 when the first and second doors 21, 31 are in the closed position. For example, a first gasket 40 may be disposed upon one of the first and second doors 21, 31, and specifically disposed along the vertical length of the inner edge of one of the first and second doors 21, 31, and more specifically along the inner edge of the frame 22, 32 of one of the first and second doors 21, 31. FIG. 3a shows the first gasket 40 disposed upon the inner edge of the frame 22 of the first door. The first gasket 40 may be configured such that the first gasket 40 engages the other of the first or second doors 21, 31 when the doors are in the closed position.

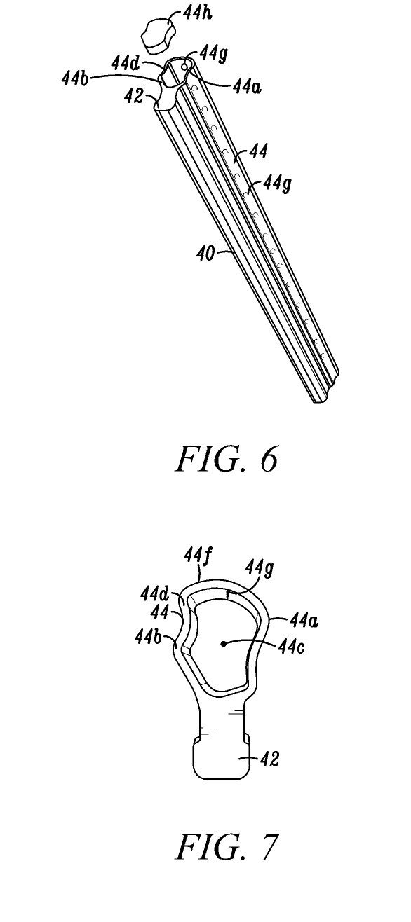

As shown in FIG. 6, the first gasket 40 may be uniform in cross-section along its length. The first gasket 40 may have a retention portion 42 and a sealing portion 44 that extends from the retention portion 42. The retention portion 42 is configured to be directly fixed to the first door 21, such as to the frame 22 of the first door 21 upon the inner edge portion of the first door 21. The sealing portion 44 of the first gasket 40 may include an arcuate strip of relatively thin material that extends from a front end 42a of the retention portion 42 and additionally returns to the front end 42a of the retention portion 42 to define an open cavity 44c therein.

In some embodiments, the sealing portion 44 may include an arcuate profile that is circular, elliptical, or another partially or fully arcuate enclosed shape. In some embodiments, the opposite right and left sides 44a, 44b (as viewed from the perspective of FIG. 7) may include the same localized curvature on each of the right and left sides, such that the right and left sides are mirror images of each other. In still other embodiments, the right and left sides 44a, 44b of the extended portion may be curved with differing profiles, due to the different types of constant and/or cyclical engagement between the first gasket 40 and the first and second doors 21, 31 as discussed below. Specifically, as shown in FIG. 7, the right side portion 44a may be more of a gradual curvature than the left side portion 44b. In some embodiments, the left side portion 44b may include a concave-out portion 44d that is configured to engage the edge 33a of the inner pane 33 of the second door 31 when the first and second doors 21, 31 are in the second position. The pre-defined concave out portion 44d is provided to minimize the compressive deformation of the first gasket 40 when the first and second doors 21, 31 are in the closed position yet still insure contact with the edge 33a of the inner pane 33 along its length to eliminate or substantially minimize leakage therebetween.

In some embodiments, the sealing portion 44 of the first gasket 40, and specifically the top surface 44f of the sealing portion 44 includes a plurality of small holes 44g defined therethrough along the length of the first gasket 40 (FIGS. 6 and 7). The holes 44g serve to vent the open cavity 44c of the extended portion to prevent any pressure buildup within the cavity 44c that may otherwise occur as the temperature within the cavity increased during oven operation. The venting insures that the sealing portion 44 may be sufficiently compressed with engagement of the inner edges 23a, 33a of the inner panes 23, 33 of the first and second doors 21, 31 thereon when the doors are in the closed position, to ensure that the first gasket forms a tight and substantially air or liquid leak proof barrier between the first and second doors. In some embodiments, the opposite ends of the extended portion 44 of the first gasket 40 may be sealed with a plug 44h (shown exploded therefrom in FIG. 6). The first gasket 40 may be made from a flexible but strong and tough polymer, with material characteristics to remain resilient at elevated temperatures (such as between 400 and 600 degrees) during oven operation. In other embodiments, the first gasket 40 may be made from silicone, plastic, graphite, Teflon, EDPM, poly-steel, poly-flex, or other suitable materials. The first gasket 40 may additionally include coatings applied thereon to improve the heat resistance, strength, or to make the first gasket 40 relatively hydrophobic. In some embodiments, the second gasket 60 (discussed in detail below) may be made from the same material as the first gasket (and/or include the same coatings as the first gasket 40), while in other embodiments, the second gasket may include different materials or coatings to modify the strength/flexibility/hydrophobicity or other relevant properties of the second gasket 60.

The second gasket 60 may be a square or rectangular member (depending on the shape of the opening in the front surface 16 of the housing 10 and may include upper, right, lower, and left sides 64, 66, 62, 68 that are each fixed to each other at mitered corners, with the cross-section of each portion of the second gasket 60 being substantially uniform in cross-section. Accordingly, the structure of the second gasket 60 will be discussed in detail with respect to the lower portion 62 of the second gasket, while the upper 64, right 66, and left portions 68 are similar.

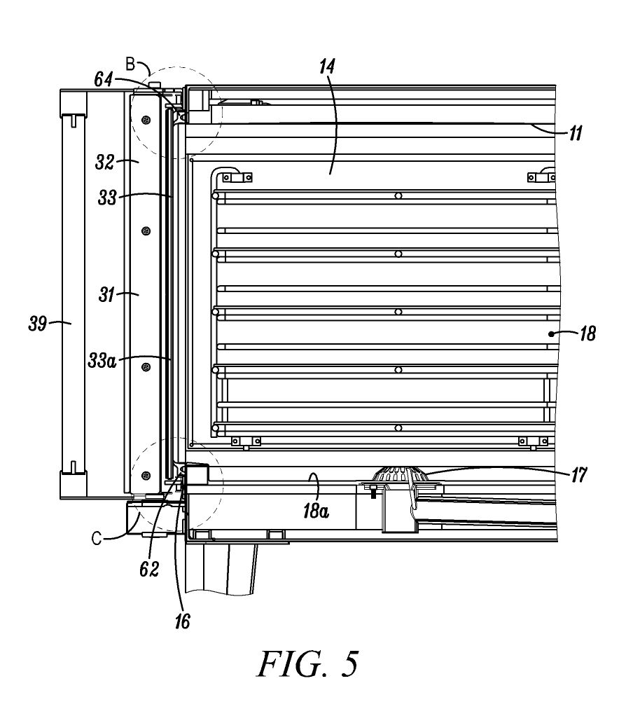

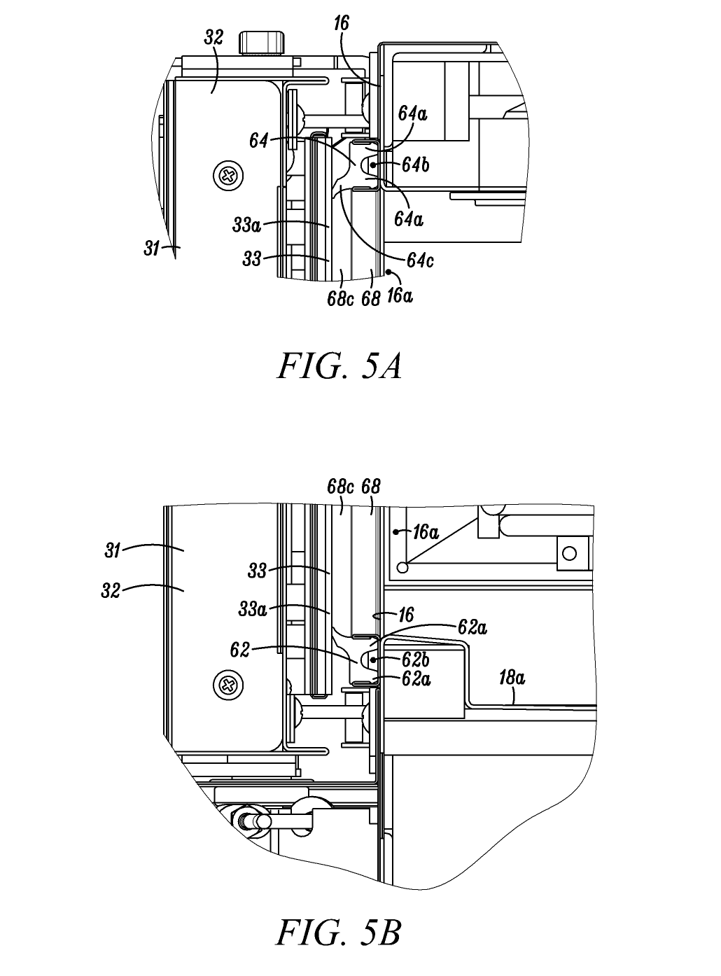

As best shown in FIGS. 5A and 5B, the second gasket includes a retention portion and an extended finger. With specific reference to FIG. 5C (depicting a detail of the lower side 62 of the second gasket 60), and the engagement between the finger 62c and the second door 31 when the second door is in the second position, the lower portion 62 of the second gasket 60 includes a retention portion with two legs 62a that extend from a central portion 62e, with a void 62b defined between the two legs 62a.

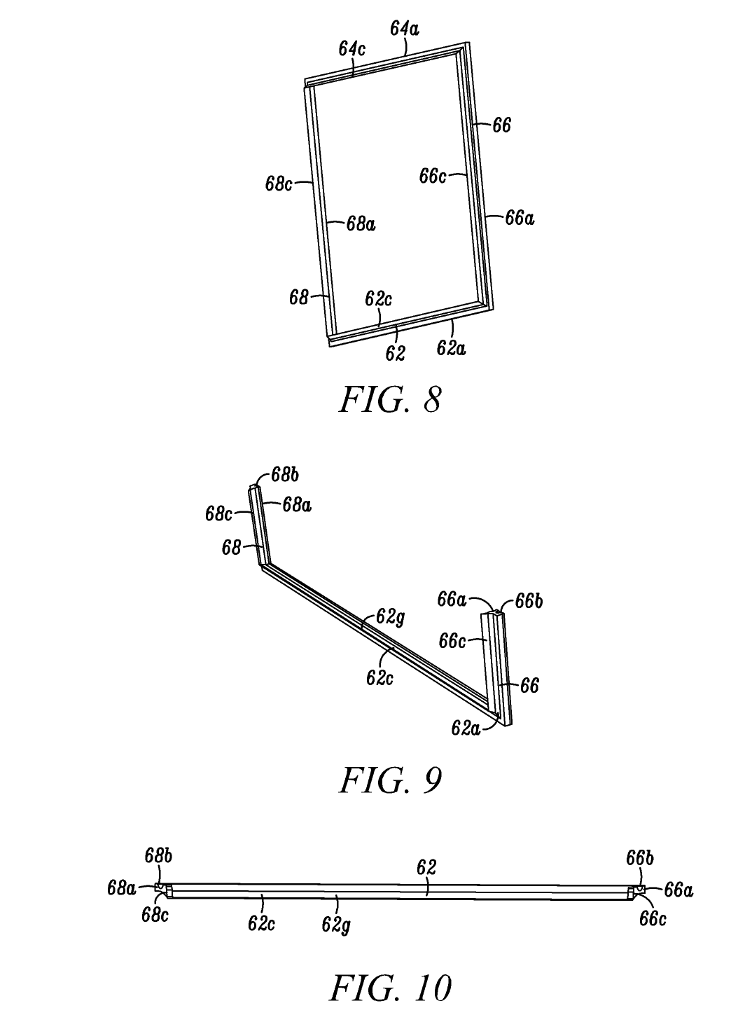

The finger 62c extends upwardly (with respect to the central portion 62e of the lower side 62 as shown in FIG. 5c) and is disposed in an arcuate configuration in both the rest condition (FIGS. 8-10) and in the biased condition when contacting the inner pane of the first and second doors (FIGS. 5-5c) and when contacting the first gasket 40 (FIGS. 3A and 4). The upward and arcuate configuration of the lower portion 62 of the second gasket 60 provides an inclined surface 62g that provides for drainage of liquid that contacts the inner pane of the doors and flows down to the second gasket when the heating volume is enclosed during operation. The liquid may be from actual drops or pools of liquid impinging upon the doors, or from the condensation of water vapor upon the inner panes 23, 33 of the first and second doors 21, 31. The inclined surface 62g urges any liquid landing or collecting upon the second gasket 60 to flow back into the heating cavity 18, and specifically flow upon angled portion 18c of the inner frame 18b and along the angled bottom wall 18a to ultimately reach the drain 17 due to the force of gravity for removal from the heating cavity 18. The finger 62a also is at a heights above the inner frame 16b and the bottom wall 16a to prevent water that may collect in a pool at the bottom of the cooking cavity 18 from leaking therefrom in situations when the drain is blocked.

The first and second gaskets 40, 60 are arranged upon the first and second doors 21, 31 and the front wall 16, respectively, such that the extended portion 44 of the first gasket 40 contacts and compresses the upper and lower portions 64, 62 of the second gasket 60 when the first and second doors 21, 31 are in the second closed position. The respective compressive contact between the first gasket 40 and the first and second doors 21, 31 along the vertical space therebetween and the compressive contact between all four portions of the second gasket 60 and the inner panes 23, 33 of the first and second doors 21, 31, and the compressive contact between the extended portion 44 of the first gasket 40 and the upper and lower portions 64, 62 of the second gasket 60 provide for a substantially leak tight seal of the heating volume 18 when the first and second doors are in the second, closed position. Operational experience has shown that the arrangement of the first and second gaskets 40, 60 is so effective at preventing leakage (both at and around room temperature, and at operational temperatures of between 400-600 degrees Fahrenheit) that the oven 1 may be configured without a drip tray disposed below the first and second doors 21, 31, which is provided on most if not all of the conventional combi ovens available in the market.

The engagement between the first and second doors 21, 31 is configured such that the first and second doors do not make direct contact with each other, but instead make indirect contact with each other with the first gasket 40 disposed therebetween.

In some embodiments, and as best depicted in FIG. 3a, the first gasket 40 is mounted to the first door along the inner edge of the first door 21 and specifically to the frame 22 of the first door 21. In some embodiments, the first gasket 40 is mounted to the frame 22 of the first door 21 with a right side portion 44a of the first gasket 40 configured to be contacted by an inner edge 23a of the inner pane 23 of the first door 21 and contacted by an inner edge 33a of the inner pane 33 of the second door 31 when each of the first and second doors 21, 31 are in the second position at a left side portion 44b thereof. In some embodiments, the first gasket 40 is mounted with respect to the first door 21 such that an extended portion 44 of the first gasket 40 is in constant contact with the inner edge 23a of the inner pane 23 on the first door 21 in all pivotal positions of the first door 21. Specifically, the first gasket 40 is positioned upon the frame 22 of the first door 21 and such that the right side portion 44a of the extended portion 44 is in contact with the inner edge 23a of the inner pane 23 of the first door 21 such that the extended portion 44 is in compression by the inner pane 23 in all pivotal positions of the first door 21.

In some embodiments, the right side portion 44a of the first gasket 40 may be slightly concave-out to minimize the stress and deformation placed upon the first gasket 40 with the constant contact with the inner pane 23 of the first door 21 while the right side portion 44a being at least partially deformed inwardly by the first pane 23 along the entire length of the first gasket 40. As discussed above, the left side portion 44b of the first gasket 40 may include a concave-out portion 44d that is configured to make contact with the inner edge 33a of the inner pane 33 of the second door when the first and second doors 21, 31 are in the second closed position. The concave-out orientation of the left side portion 44d allows for consistent cyclical contact with the inner pane, with sufficient compression thereof to insure a substantially leak tight barrier along the entire length of the first gasket 40.

In some embodiments, the second door 31 may include a steam choke 38 mounted to the frame 32 or the outer panel 34 of the second door 31. The steam choke 38 may be a thin metal bracket, such as an “L” shaped bracket that is mounted to contact the frame 22 or the outer panel 24 of the first door 21 when the doors are in the closed position. The steam choke 38 is pressed slightly outward when contacting the outer surface of the first door 21. The steam choke 38 may serve at least two functions, a first function to serve as a steam shield to block steam or heated air from leaving directly from the heating cavity 18 through the aperture 16a and between the first and second doors 21, 31 in situations when the first gasket 40 develops a hole, either through gradual material degradation from extended cyclic use, or if cut or broken during use. A second function is to urge the first and second doors 21, 31 to remain in the closed position due to the inward biasing force placed upon the first door 21 by the steam choke 28.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

What is claimed is:

1. An oven comprising:
a housing defining an internal cooking volume defined by a plurality of side walls, a front wall, and a bottom wall;
a source of heat disposed in conjunction with the cooking volume;
a first and second doors pivotably mounted to the front wall, each door proximate to opposite side walls of the housing, the first and second doors pivotable between a first position to allow access to the cooking volume through an aperture in the front wall and a second position to enclose the cooking volume;
a straight and elongate first gasket disposed upon one of the first or second doors such that the gasket engages the other of the first and second doors when the doors are in the second position, the gasket forming a seal between an elongate interface between the first and second doors when in the second position; and
a second gasket disposed upon the front wall along a perimeter of the housing, wherein the first gasket contacts a portion of the second gasket when the first and second doors are in the second position.

2. The oven of claim 1, wherein the second gasket has an upper portion, a right portion, a left portion, and a lower portion that are each disposed around an aperture defined in the housing to allow communication with the cooking volume, wherein the first gasket contacts opposite portions of the second gasket when the first and second doors are in the second position.

3. The oven of claim 1, wherein the first door is mounted proximate to a right side wall of the housing and the second door is mounted proximate to a left side wall of the housing.

4. The oven of claim 1, wherein the second gasket includes a central portion defining a first surface fixed to the perimeter of the housing and an extended finger engages the first gasket and inner surfaces of the first and second doors when the first and second doors are in the second position.

5. The oven of claim 4, wherein the engagement of the second gasket with each of the first gasket and the inner surfaces of each of the first and second doors biasingly urges the finger toward the cooking volume.

6. The oven of claim 4, wherein the finger contacts the inner surface of each of the first and second doors at positions remote from contact between the finger and the first gasket.

7. The oven of claim 4, wherein the finger contacts the first gasket proximate to both opposite ends of the first gasket.

8. The oven of claim 4, wherein the engagement of the second gasket with the first gasket compresses each of the first and second gaskets to substantially eliminate any space between the first and second gaskets at the points of contact.

9. The oven of claim 1, wherein a cross-section of the second gasket is substantially uniform along its length, the cross-section comprising a central portion with two legs that contact the front surface of the housing defining a hollow portion therebetween and a finger that extends from the central portion in a cantilevered manner, the finger is engaged by the first gasket and biased toward the internal cooking volume when the first and second doors are in the closed position.

10. The oven of claim 1, wherein the first gasket comprises a support portion directly fixed to the first or second door and an extended portion extending in a cantilevered fashion from the respective first or second door, wherein the extended portion makes constant contact with an inner edge of the first or second door carrying the first gasket along the entire length of the first gasket.

11. The oven of claim 10, wherein the extended portion contacts an inner edge of the other of the first or second door when the first and second doors are in the second position.

12. The oven of claim 10, wherein the first gasket is relatively consistent geometry along its length.

13. The oven of claim 10, wherein the extended portion includes an arcuate outer wall that defines an enclosed hollow portion therewithin.

14. The oven of claim 13, wherein the extended portion includes a plurality of apertures defined through the outer wall thereof disposed at spaced distances along the length of the extended portion, the apertures being disposed through a portion of the extended path substantially opposite the support portion.

15. The oven of claim 13, wherein opposite end portions of the extended portion are capped to substantially enclose the hollow portion.

16. The oven of claim 1, further comprising a source of liquid disposed in conjunction with the cooking volume and configured to provide steam within the cooking volume, wherein the cooperation of the first and second gaskets substantially prevents moisture communication to the environment from the cooking volume.

17. The oven of claim 16, wherein the oven is constructed without a drip tray disposed outside of the cooking volume below the first and second doors.

18. The oven of claim 4, wherein the extended finger contacts the inner surface of the first and second doors when the first and second doors are in the second position, except at a central position where the extended finger contacts the first gasket.

19. The oven of claim 5, wherein a extended finger upon the lower portion of the second gasket extends above a top surface of the bottom wall when the first and second doors are in the second position to establish a lip within the cooking volume.

20. The oven of claim 19, wherein the top surface of the bottom wall is disposed at a downward angle into the cooking volume from a front opening to facilitate gravity drainage of fluid disposed within the cooking volume.

21. An oven comprising:
a housing defining an internal cooking volume and an opening to access the internal cooking volume;
a radiant heat source disposed in conjunction with the cooking volume, a source of liquid disposed in conjunction with the cooking volume and configured to provide steam within the internal cooking volume;
first and second doors pivotably connected to opposite side walls of the housing pivotable between a first position to allow access to the cooking volume and a second position to enclose the cooking volume;
wherein the first and second doors each include an inner surface that each are disposed within substantially the same plane when the first and second doors are in the second position;
a first gasket fixed to an end surface of the first door, the first gasket including a cantilevered extended portion that is internally compressed by continuous contact with an inner edge of the inner surface of the first door along the length thereof, wherein the first gasket establishes continuous contact with and is inwardly compressed by an inner edge of the inner surface of the second door along the length thereof when the first and second doors are in the second position;
a second gasket disposed upon the housing and surrounding the opening, the second gasket including a body portion fixed to the housing and a finger extending arcuately therefrom, the finger of the second gasket configured to contact the inner surface of the each of the first and second doors and the extended portion of each opposite end of the first gasket when the first and second doors are in the second position.
